(19) United States
(12) Patent Application Publication
(10) Pub. No.: US 2002/0066803 A1
(43) Pub. Date: Jun. 6, 2002

(54) PISTOL NOZZLE

(76) Inventor: Chao-Te Hsu, Chang Hua Hsien (TW)

Correspondence Address: Harrison and Egbert, 412 Main Street 7th Floor, Houston, TX, 77002, US

(21) Appl. No.: 09/728,906

(22) Filed: Dec. 4, 2000

(51) Int. Cl. B05B 9/01; B05B 15/08

(52) U.S. Cl. 239/530; 239/532

(57) ABSTRACT

A pistol nozzle is designed to emit a compressed fluid and is formed of a main body and a telescopic barrel set. The main body is provided with a trigger, a retaining hook, a fluid emitting end, and a fluid admission end which is fastened with a fluid pipe. The telescopic barrel set is fastened with the fluid emitting end of the main body and is formed of a fastening mount, a plurality of telescopic tubes, a plurality of stop members, and a plurality of washers. The fastening mount is fastened at one end with the fluid emitting end of the main body and is provided at other end with a stepped and threaded portion. The telescopic tubes are fastened at the base end thereof with the stepped and threaded portion of the fastening mount at such time when they are collapsed together. The telescopic tubes are extended in conjunction with the stop members and the washers.

### BACKGROUND OF THE INVENTION

1. Field of the Invention

The present invention relates generally to a pistol nozzle, and more particularly to a pistol nozzle having a telescopic barrel, through which a compressed fluid is emitted.

2. Description of Related Art

As shown in FIGS. 1 and 2, a pistol nozzle of the prior art has a main body 10 which is provided with a trigger 101, and a handle 102 connected with a fluid pipe. The main body 10 is fastened at the front end with a telescopic barrel 11, through which the fluid is emitted. The telescopic barrel 11 has a plurality of sections that slide one into another. The telescopic barrel 11 of the prior art pistol nozzle is defective in design in that its outermost section is apt to be forced out by the compressed fluid at the time when the telescopic barrel 11 is at work in the collapsed state. As a result, the outermost section of the telescopic barrel 11 in action may come in contact with a foreign object, thereby resulting in contamination of the telescopic barrel 11 by the foreign object.

### BRIEF SUMMARY OF THE INVENTION

The primary objective of the present invention is to provide a pistol nozzle with a telescopic barrel free of the drawback of the prior art pistol nozzle described above.

In keeping with the principle of the present invention, the foregoing objective of the present invention is attained by a pistol nozzle comprising a main body, a telescopic barrel having a plurality of sections, and a locating member for preventing the telescopic barrel from being displaced by the force of the compressed fluid flowing through the telescopic barrel.

The features, functions, and advantages of the present invention will be more readily understood upon a thoughtful deliberation of the following detailed description of a preferred embodiment of the present invention with reference to the accompanying drawings.

### BRIEF DESCIPTION OF THE SEVERAL VIEWS OF THE DRAWINGS

FIG. 1 shows a perspective view of a pistol nozzle of the prior art.

FIG. 2 shows a schematic view of the prior art pistol nozzle in use.

FIG. 3 shows a perspective view of the preferred embodiment of the present invention.

FIG. 4 shows an exploded view of the preferred embodiment of the present invention.

FIGS. 5-8 are schematic views of the preferred embodiment of the present invention in use.

FIG. 9 shows a sectional view of the telescopic tube of the preferred embodiment of the present invention.

FIG. 10 shows another sectional view of the telescopic tube of the preferred embodiment of the present invention.

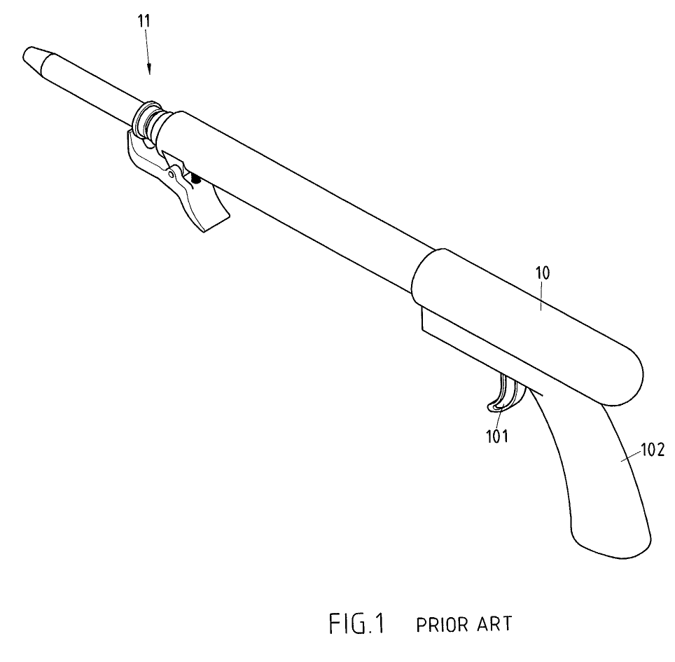

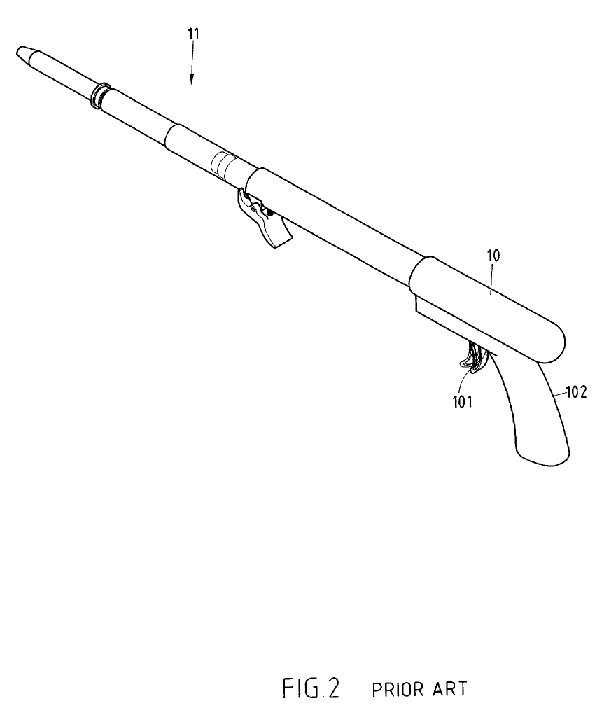

### DETAILED DESCRIPTION OF THE INVENTION

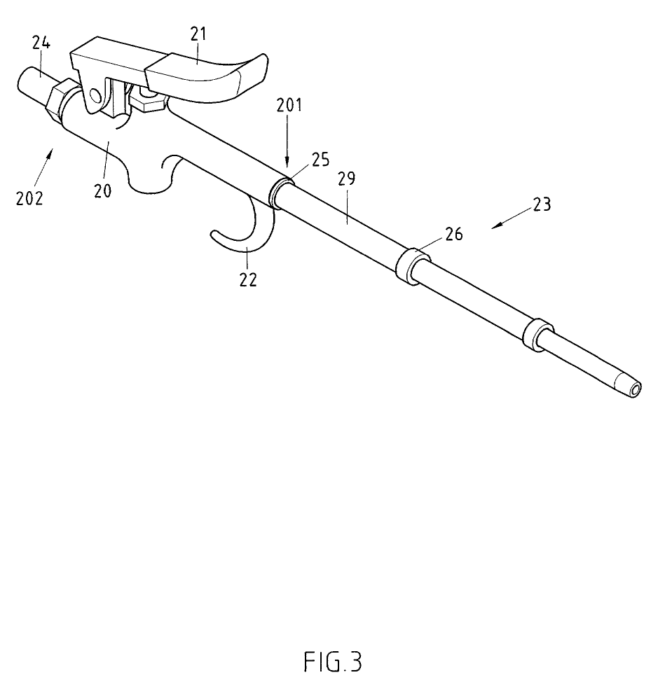

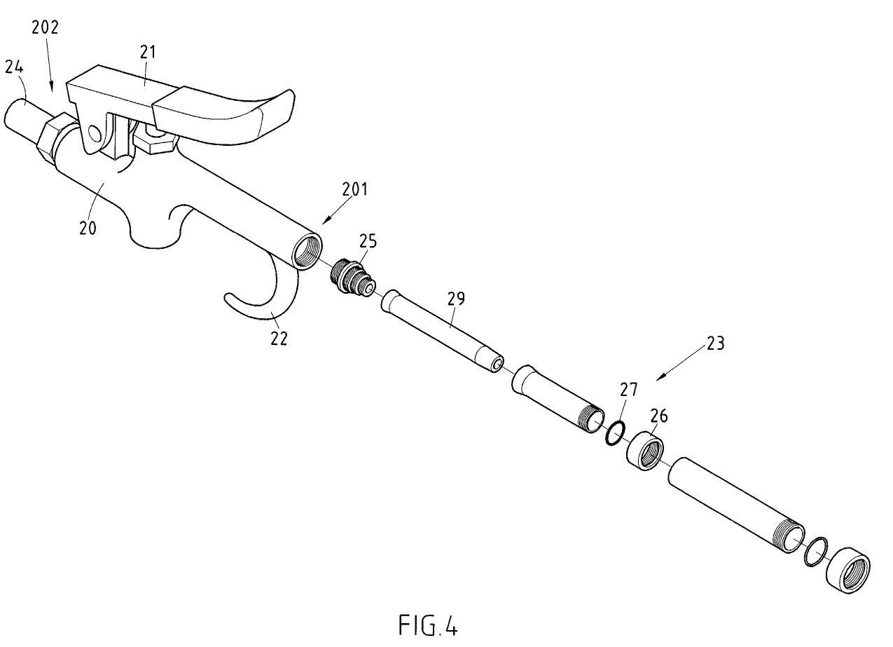

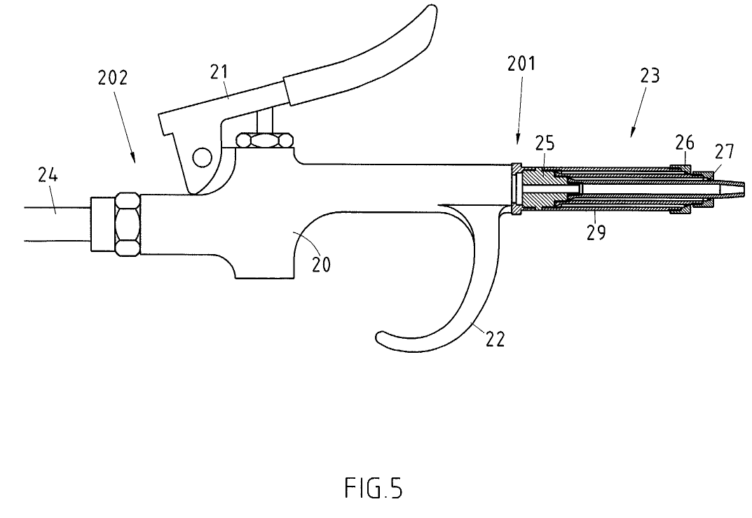

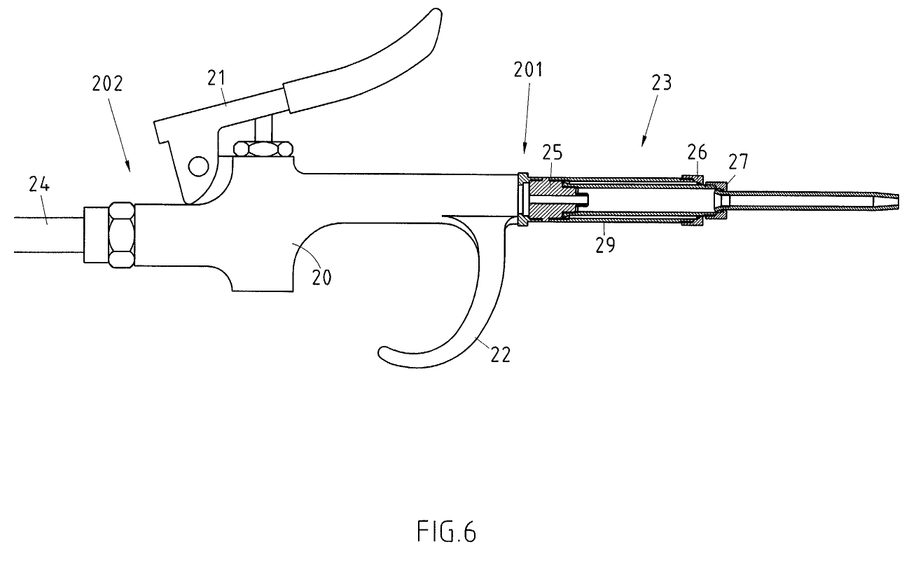

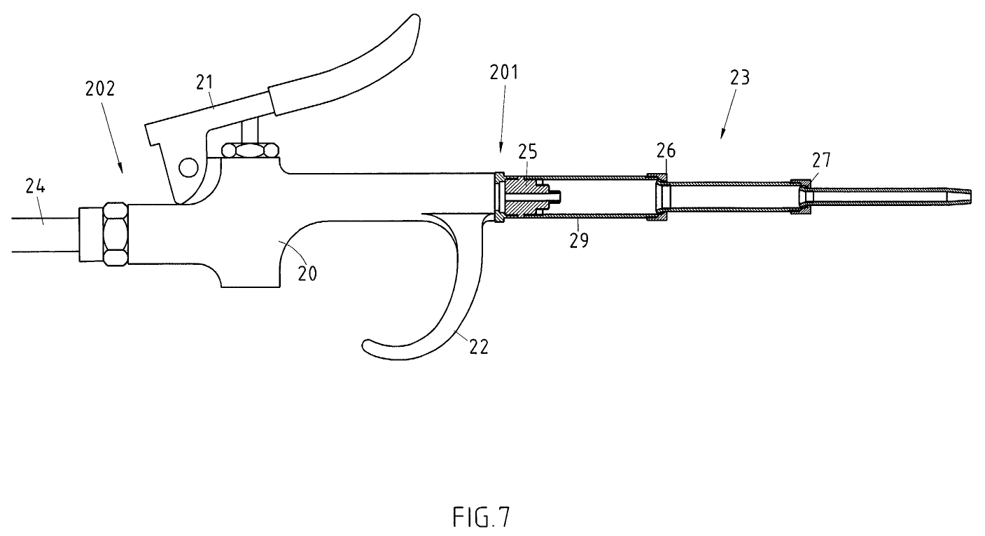

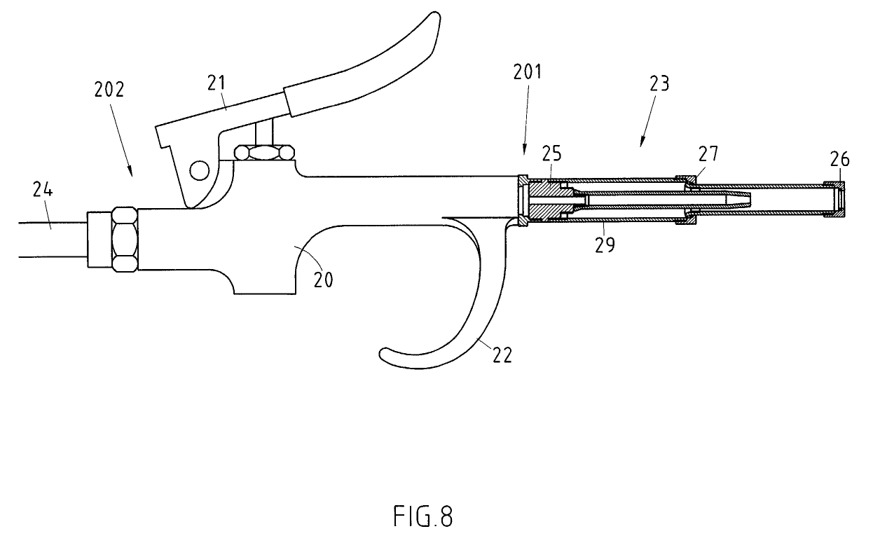

As shown in FIGS. 3-10, a pistol nozzle embodied in the present invention comprises a main body 20 and a telescopic barrel set 23.

The main body 20 is provided with a trigger 21, a retaining hook 22, a fluid emitting end 201, and a fluid admission end 202 which is fastened with a fluid pipe 24.

The pistol nozzle of the preferred embodiment of the present invention is characterized by the telescopic barrel set 23, which is fastened with the fluid emitting end 201 of the main body 20 and is formed of a fastening mount 25, a plurality of telescopic tubes 29, a plurality of stop members 26, and a plurality of washers 27.

The fastening mount 25 is provided at one end with outer threads, which are engaged with the inner threads of the fluid emitting end 201 of the main body. The fastening mount 25 is further provided at other end with a stepped and threaded portion.

The telescopic 29 are different in diameter from one another and are fastened at the base end thereof with the stepped and threaded portion of the fastening mount 25 at such time when the telescopic tubes 29 are collapsed together. The telescopic tubes 29 are provided at the base end with inner threads, and at the outer end with outer threads. When the telescopic tubes 29 are extended, they are fastened end to end such that the outer threads of the outer end of one telescopic tube 29 are engaged with the inner threads of the base end of another telescopic tube 29 in conjunction with a stop member 26 and a washer 27. The stop members 26 are intended to locate the telescopic tubes 29 and are provided with inner threads engageable with the outer threads of the telescopic tubes 29. The washers 27 are intended to prevent the leak of the compressed fluid.

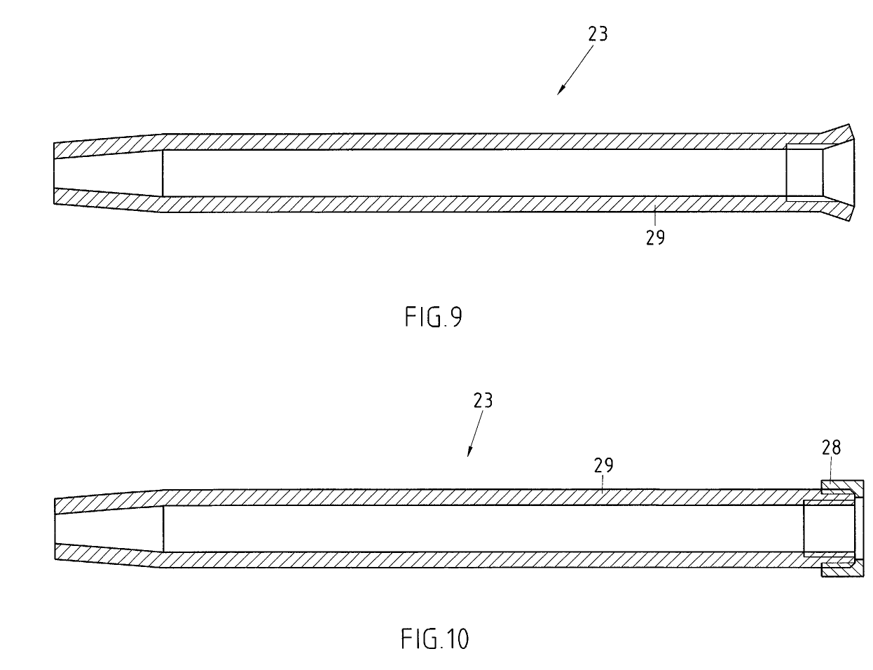

As shown in FIG. 9, the telescopic tube 29 is provided at an expansion end thereof with a stop sleeve 28 fitted thereover.

The embodiment of the present invention described above is to be regarded in all respects as being merely illustrative and not restrictive. Accordingly, the present invention may be embodied in other specific forms without deviating from the spirit thereof. The present invention is therefore to be limited only by the scopes of the following appended claims.

I claim:

1. A pistol nozzle comprising:
a main body provided with a trigger, a retaining hook, a fluid emitting end, and a fluid admission end which is fastened with one end of a fluid pipe; and
a telescopic barrel set fastened with said fluid emitting end of said main body for discharging the fluid;
wherein said telescopic barrel set comprises:
a fastening mount provided at one end with outer threads, which are engaged with inner threads of said fluid emitting end of said main body, said fastening mount being further provided at other end with a stepped and threaded portion; and
a plurality of telescopic tubes different in diameter from one another and being fastened at a base end thereof with said stepped and threaded portion of said fastening mount at such time when said telescopic tubes are collapsed together, said telescopic tubes being extended end to end in conjunction with a stop member and a washer whereby said stop member is intended to locate said telescopic tubes.

2. The pistol nozzle as defined in claim 1, wherein said telescopic tubes have an outer end opposite to said base end, said outer end being provided with outer threads; wherein said stop member is provided with inner threads which are engaged with said outer threads of said outer end of said telescopic tube.
